(19) United States
(12) Patent Application Publication
(10) Pub. No.: US 2026/0077754 A1
(43) Pub. Date: Mar. 19, 2026

(54) ROTATIONAL-ANGLE DETECTION SYSTEM FOR DETECTING THE ROTATIONAL ANGLE OF A ROTARY BRAKE DRIVE FOR A RAIL VEHICLE

(71) Applicant: KNORR-BREMSE SYSTEME FÜR SCHIENENFAHRZEUGE GMBH, Munich (DE)

(72) Inventors: Alexander JUNG, Gauting (DE); Ulf FRIESEN, Neubiberg (DE); Cheng LIU, Munich (DE); Richard GRUNDWÜRMER, Ingolstadt (DE)

(21) Appl. No.: 19/110,529

(22) PCT Filed: Aug. 25, 2023
(86) PCT No.: PCT/EP2023/073359

§ 371 Date: Mar. 11, 2025

(30) Foreign Application Priority Data
Sep. 12, 2022 (DE) 10 2022 123 082.1

(51) Int. Cl. B60T 17/22; B61K 9/00; F16D 66/00; G01B 7/30; G01D 5/20

(52) U.S. Cl. CPC B60T 17/228; B61K 9/00; F16D 66/00; G01B 7/30; G01D 5/20; B60T 2270/413; F16D 2066/003

(57) ABSTRACT

A rotational-angle detection system detects the rotational angle of a rotary brake drive for a rail vehicle and includes at least one sensor unit for detecting a rotational angle, which is operatively connectable to the rotary brake drive, and at least one electronics main path and at least one electronics safety path for each sensor unit, wherein the at least one electronics main path and the at least one electronics safety path is each operatively connectable to the at least one sensor unit as an individual path, wherein the at least one electronics main path and the at least one electronics safety path each includes at least one signal provision unit.

### CROSS REFERENCE AND PRIORITY CLAIM

This patent application is a U.S. National Phase of International Patent Application No. PCT/EP2023/073359 filed Aug. 25, 2023, which claims priority to German Patent Application No. 10 2022 123 082.1, the disclosure of which being incorporated herein by reference in their entireties.

### FIELD

Disclosed embodiments relate to a rotation-angle detection system for detecting the rotation angle of a rotary brake drive for a rail vehicle, and also to a braking system for a rail vehicle and to a rail vehicle with such a rotation-angle detection system.

### BACKGROUND

In rail vehicles, electromechanical brake actuators such as brake cylinders, for instance, are configured in such a manner that electrical energy is transformed into mechanical energy with the aid of an electric motor. When the brake actuator, or brake cylinder, is actuated, the rotor of the electric motor is set in rotary motion. This rotation—or, to be more exact, the associated drive torque—is transmitted via a shaft to a spindle nut incorporated therein or thereon. Axial fixing of the spindle nut results in a feed motion of the spindle as an example of a converter of a rotary motion into a linear motion. In a further step, a movement of the caliper levers occurs by means of a mechanical transmission stage, resulting in an application of the brake pads to a brake disc, and in the build-up of a contact force of the pads. For the purpose of releasing the brake, the motor rotates in the opposite direction and thereby resets the screw drive.

For the triggering of the electric motor—for instance, a synchronous machine excited by a permanent magnet, or PMSM for short—a rotation-angle transducer for detecting the position of the rotor is employed. With a view to achieving a high level of failure safety of the drive system, as in the case of safety integrity level 4 (SIL4), use is therefore frequently made of at least two transducer systems, since in the event of the failure of one transducer system there is consequently a redundancy.

By reason of the cramped spatial conditions for an appropriate installation, however, and also from the point of view of cost, two or more sensors and components can only be realized with great difficulty, if at all. This applies, in particular, to a brake-actuator housing of a rail vehicle, which is limited in its maximum dimensions by reason of the spatial conditions in the truck.

### SUMMARY

In view of the above remarks, disclosed embodiments provide an improved rotation-angle detection system with regard to the requisite construction space.

More specifically, a rotation-angle detection system is provided for detecting the rotation angle of a rotary brake drive for a rail vehicle includes at least one sensor unit for detecting a rotation angle, which is capable of being operationally connected to the rotary brake drive, and also at least one electronics main path and at least one electronics safety path per sensor unit, the at least one electronics main path and the at least one electronics safety path each being capable, as a single path, of being operationally connected to the at least one sensor unit, the at least one electronics main path and the at least one electronics safety path each including at least one signal-conditioning unit.

### BRIEF DESCRIPTION OF THE FIGURES

Disclosed embodiments are described in the following with the aid of the attached drawings.

FIG. 1 shows a schematic representation of a rotation-angle detection system for a rail vehicle, according to an first embodiment; and

FIG. 2 shows a schematic representation of a rotation-angle detection system for a rail vehicle, according to a second embodiment.

### DETAILED DESCRIPTION

The fundamental idea on which the disclosed embodiments is based is consequently to use—instead of two or more complete sensor paths which include both the sensor unit as such and a signal-conditioning unit, for instance appropriate signal-processing electronics—a sensor unit with two or more signal-conditioning units, in order to achieve a redundancy, at least one of the signal-conditioning units having been respectively assigned to an electronics main path, and at least one of the signal-conditioning units having been respectively assigned to an electronics safety path.

The electronics main path and the electronics safety path are individual paths, separate from one another, which are connected to one another in parallel, or alternatively run separately in principle. The electronics main path may be understood as being the electronics path that in trouble-free operation is operationally connected to the sensor unit, in order by this means to be able to conduct sensor signals or further, different, signals, such as triggering signals or such like, unidirectionally or bidirectionally. Accordingly, the electronics safety path can be, or become, operationally connected to the sensor unit only when a malfunction prohibits, or otherwise interferes with, a transmission via the electronics main path. Alternatively, the electronics main path and the electronics safety path may have been permanently or at least temporarily operationally connected to the sensor unit simultaneously, so that a check of the plausibility of the transmitted signals is made possible, or alternatively, even in the event of failure of the electronics main path, the signals are capable of being transmitted without delay via the electronics safety path. The operational connectivity of the electronics main path and of the electronics safety path concerns both a direct and an indirect connection of the individual paths for the purpose of signal transmission. In addition, the operational connection may also relate to an actual activation of the individual paths, or of the respective signal-conditioning unit. In other words, at least one of the signal-conditioning units may, for instance, have been constantly physically connected to the sensor unit, in which case, strictly speaking, an operational connection is effected only upon activation of the corresponding signal-conditioning unit.

The operational connectivity of the sensor unit to the rotary brake drive may equally encompass both a direct and an indirect connection. The connection can be effected mechanically and/or by means of signaling. The sensor unit can consequently generate, both in direct contact and via optical, acoustic and/or electrical or electromagnetic signals in interaction with the rotary brake drive, at least one signal representing a rotation angle, which can be relayed to the respective signal-conditioning unit via the electronics main path and/or the electronics safety path.

By virtue of the configuration of the rotation-angle detection system with one sensor unit with redundant individual paths, a reduction of the requisite construction space can be assisted, in particular, by virtue of the fact that the respective signal-conditioning units can be realized by small microelectronic and/or highly integrated modules which have a comparatively small space requirement even in the case of redundant implementation of the individual paths. The redundant implementation of the individual paths—that is to say, of the electronics safety path with regard to the electronics main path—or of respective signal-conditioning units, may relate to an identical functional implementation or alternatively to a redundancy of predetermined functions—in particular functions that are relevant to safety.

According to one configuration, the sensor unit is endowed with a higher level of failure safety than the at least one electronics main path and/or the at least one electronics safety path. In particular, the sensor unit includes enduring properties with respect to the higher level of failure safety.

Accordingly, the sensor unit—such as a single sensor element, for instance—is implemented in appropriately simple, reliable and fail-safe manner, in order to achieve a level of failure safety that is as high as possible. This can be done, for example, by means of suitable measures such as a durable mechanical design, reinforced insulation, larger cable cross-sections and/or the use of aging-resistant materials. In particular, the sensor unit is implemented in such a way that its properties are “enduring” over a defined period of use or even over its entire service life. The term “enduring properties” in this context relates to a failure that is not to be accepted. Since the signal-conditioning units, or individual paths connected thereto, have been implemented in redundant manner, at least in terms of predefined functionalities, functionalities with lower failure safety can be rerouted to these individual paths. Precisely with regard to a signal-conditioning unit with corresponding components of, for the most part, comparatively higher complexity, which have a higher probability of failure, the higher probability of failure can be at least partly compensated by the redundancy.

According to one configuration, the signal-conditioning unit of the at least one electronics main path and/or of the at least one electronics safety path includes at least one signal-converter.

Via the at least one signal-converter, sensor signals communicated from the sensor unit can, for instance, be transformed into signals that are capable of being processed by further signal-conditioning components. The signal-converter may be, for example, an A/D converter which converts an analog signal of the sensor unit into a digital format.

According to one configuration, the signal-conditioning unit of the at least one electronics main path and/or of the at least one electronics safety path includes at least one signal-processing unit.

For instance, the signal of the sensor unit, which optionally has previously been converted via the signal-converter, is processed further by the signal-processing unit. The further processing may be, amongst other things, a computation to yield a different quantity, taking further signal inputs into consideration, and/or a different form of signal-processing, in order to determine a rotation angle of the rotary brake drive on the basis of the signal of the sensor unit.

According to one configuration, the signal-conditioning unit of the at least one electronics main path and/or of the at least one electronics safety path includes at least one signal-output unit.

The signal-output unit outputs the rotation angle of the rotary brake drive ascertained on the basis of the signal of the sensor unit. The signal-output unit may be a separate unit of the signal-conditioning unit, or may alternatively have been integrated within the above signal-processing unit. Conversely, the signal-output unit may also include signal-processing functions.

According to one configuration, the at least one electronics main path and/or the at least one electronics safety path includes at least one signal switch via which the at least one signal-conditioning unit is capable of being operationally connected to the at least one sensor unit.

Via such a signal switch, the at least one electronics main path and/or the at least one electronics safety path can consequently be optionally connected to the sensor unit and isolated again. To the extent that a fault in the at least one electronics main path and/or in the at least one electronics safety path were to be transmissible to the sensor unit, or might otherwise have a negative effect on the sensor unit, this is prohibited by an isolation of the faulty individual path. In addition, the targeted connection to the sensor unit can also be effected via the signal switch. For instance, first of all only one individual path can be connected to the sensor unit, in which case in the event of a corresponding failure of this individual path, or for other reasons, the other individual path is switched in via the signal switch, or is switched over to this signal switch. The term “switching in” relates to the connection of both individual paths, whereas in the case of “switching over” the previous individual path is isolated.

According to one configuration, the at least one electronics main path and/or the at least one electronics safety path includes at least one power-supply unit which is capable of being operationally connected to the at least one sensor unit.

The sensor unit consequently does not inevitably need its own power supply, but can be supplied with power via the at least one electronics main path and/or via the at least one electronics safety path. If both the at least one electronics main path and/or the at least one electronics safety path include at least one power-supply unit or an appropriate link to a power-supply unit, the failure safety can be enhanced further.

According to one configuration, the at least one electronics main path and/or the at least one electronics safety path includes at least one power-supply switch via which at least one power-supply unit is capable of being operationally connected to the at least one sensor unit.

In a manner comparable to the signal switch, here too a targeted connection and isolation of the respective power-supply unit can consequently be effected.

In particular, the at least one electronics main path and/or the at least one electronics safety path and/or the at least one signal switch and/or the at least one power-supply switch is/are capable of being triggered via a triggering signal of a triggering unit.

Such a triggering unit optionally includes a monitoring function or is connected to an appropriate monitoring unit at least by means of signaling, in order to trigger the at least one signal switch and/or the at least one power-supply switch via a triggering signal in the case of a failure or fault of an individual path or of a signal-conditioning unit or power-supply unit. The triggering may have been designed in such a manner that, first of all, the at least one electronics main path is triggered, and only in the event of an absence of feedback, or in accordance with a fault detected otherwise, the at least one electronics safety path is triggered. Corresponding to this, the triggering unit can then also trigger the at least one signal switch and/or the at least one power-supply switch. The triggering of the at least one signal switch and/or of the at least one power-supply switch can also be effected via the respective at least one electronics main path and/or the at least one electronics safety path. The triggering unit may be part of the rotation-angle detection system-for instance, part of the at least one electronics main path and/or of the at least one electronics safety path-or may alternatively be an external triggering unit.

According to one configuration, the sensor unit is a resolver or includes at least one resolver.

A resolver is a rotation-angle sensor which includes, like an electric motor, a rotor and a stator. The rotor of the resolver may have been formed from a magnetically readily conductive material and may constitute the magnetic yoke for the magnetic field generated by the stator. If the winding in the stator of the resolver is considered, two different regions can be distinguished. The first region corresponds to a rotary transformer, the winding here being arranged concentrically around the rotor. In the second region, the structure of the winding corresponds to the structure of a motor winding with two phases which, however, are not connected to one another. The two winding regions are spatially separated from one another and magnetically coupled only by the rotor and the stator yoke. For instance, the excitation winding of the resolver is excited with a sinusoidal or rectangular high-frequency voltage, typically within the range from 2 kHz to 10 kHz. The alternating magnetic field is transmitted by the rotor exclusively to the measuring windings and is modulated in its amplitude. The voltages in the measuring windings can be drawn upon as quantities for evaluation. A sinusoidal oscillation and a cosinusoidal oscillation are then specified as output signals. Since the magnetic excitation of the rotor is effected with an alternating voltage of constant amplitude, in the measuring windings it induces a voltage, the amplitude of which is independent of the speed of rotation of the shaft of the brake drive. The amplitudes of the voltages in the measuring windings consequently depend only on the rotor angle—or, to be more exact, on the position of the rotor or shaft.

By reason of the structure of the resolver, in which no mechanical components with wear behavior—such as ball bearings, for example—and no electronic components—such as, for instance, microprocessors, semiconductors or capacitors with solid electrolyte—come into operation, the resolver itself offers a very high level of failure safety.

In particular, the at least one electronics main path and/or the at least one electronics safety path includes at least one resolver digital converter.

Through the use of at least one resolver digital converter, the resolver can be operated in straightforward manner as a sensor unit. Since a resolver digital converter is a microprocessor-like electronic component which has a complex structure and/or is subject to a lower level of failure safety, at least one resolver digital converter is provided both in the at least one electronics main path and in the at least one electronics safety path.

According to one development, the at least one resolver digital converter has been designed to excite a rotor of the resolver magnetically, in particular with an alternating voltage of constant amplitude, and to receive sine-wave signals and cosine-wave signals of a stator of the resolver.

According to the mode of operation, stated above, of the resolver, the triggering signals, or excitation signals, for the resolver can consequently be transmitted by the resolver digital converter, and, conversely, output signals representing the rotation angle can be received from the resolver. Accordingly, the at least one resolver digital converter may have been designed for the generation of the appropriate excitation signal for the resolver. In addition, the at least one resolver digital converter may have been designed not only to receive the two output signals of the resolver—that is to say, the sine-wave signals and cosine-wave signals—but also to process them further and to relay a rotation angle of the rotary brake drive, or an output signal representing this rotation angle, as measured quantity to a higher-ranking system, for example via a digital interface.

According to one configuration, the at least one resolver digital converter or a further signal-conditioning unit has been designed to determine the rotation-angle position from the sine-wave signals and cosine-wave signals of the stator of the resolver, in particular taking a number of pole-pairs of the resolver into consideration.

The evaluation of the resolver signals—that is to say, the sine-wave signals and cosine-wave signals—is effected, for instance, via the formation of the inverse tangent, as a result of which the electrical rotation-angle position can be output. By incorporation of the number of pole-pairs of the resolver, output as a mechanical rotation-angle position is also possible. Furthermore, a diagnosis of the resolver by the two output signals and the application of trigonometrical computations is possible.

According to a further aspect, a braking system for a rail vehicle includes at least one brake actuator for applying a braking force, at least one rotary brake drive for actuating the brake actuator, and also at least one rotation-angle detection system described above.

The features described in the above description of the rotation-angle detection system relate equally to advantageous developments of the brake system according to the disclosed embodiments, and conversely.

According to a further aspect, disclosed embodiments relate to a rail vehicle with at least one rotation-angle detection system described above and/or with a braking system described above, wherein at least the sensor unit is arranged in a truck of the rail vehicle.

The features described in the above description of the rotation-angle detection system relate equally to advantageous developments of the rail vehicle according to the disclosed embodiments, and conversely.

The disclosed embodiments described above and below are not to be regarded as limiting with respect to the subject-matter of the disclosed embodiments. Rather, further details regarding the disclosed embodiments can be obtained by supplementing, omitting or exchanging individual features.

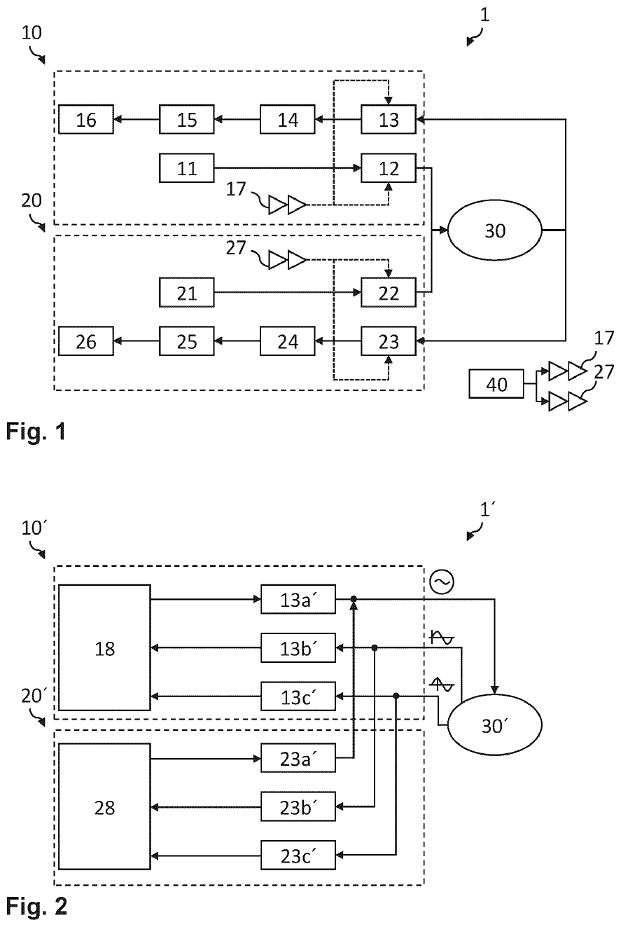

FIG. 1 shows a schematic representation of a rotation-angle detection system 1 for a rail vehicle, according to a first embodiment. The rotation-angle detection system 1 includes a sensor unit 30 which can detect the rotation angle of a rotary brake drive (not shown) of a rail vehicle. For this purpose, the rotation-angle detection system is arranged in a truck—here, for instance, in an electromechanical brake caliper which is arranged in a truck of the rail vehicle. In alternative embodiments, the rotation-angle detection system 1 may also have been arranged only partly in the brake caliper or in the truck.

In addition, the rotation-angle detection system 1 includes an electronics main path 10 and also an electronics safety path 20, which are connected to the sensor unit 30, in each instance as individual paths. The electronics main path 10 and the electronics safety path 20 respectively include a signal-converter 14, 24, a signal-processing unit 15, 25 and a signal-output unit 16, 26 as parts of a signal-conditioning unit which is formed from these components which condition the sensor signal of the sensor unit. Furthermore, the electronics main path 10 and the electronics safety path 20 respectively include a power-supply unit 11, 21, in order to be able to supply the sensor unit with power. The connection of the sensor unit 30 for the supply of power by the respective power-supply unit 11, 21 is effected via a respective power-supply switch 12, 22. In comparable manner, the connection of the sensor unit for the purpose of signal-conditioning is effected via the respective signal-converters 14, 24, the respective signal-processing units 15, 25 and the respective signal-output units 16, 26 via a respective signal switch 13, 23. The signal switches 13, 23 and the power-supply switches 12, 22 are triggered by a respective triggering signal 17, 27 which is provided by a control unit 40. Triggering signal 17 serves for triggering the signal switch 13 and the power-supply switch 12 of the electronics main path 10, whereas the signal switch 23 and the power-supply switch 22 of the electronics safety path 20 are triggered via triggering signal 27. If the rotation-angle detection and the power supply are implemented, for instance, via the electronics main path, and a fault or failure is detected in the course of the implementation, the control unit 40 outputs a triggering signal 17, in order to open signal switch 13 and power-supply switch 12 and thereby to isolate a respective connection to the sensor unit 30. In addition, in this respect the control unit 40 outputs a triggering signal 27 to the electronics safety path 20, in order to close signal switch 23 and power-supply switch 22, so that the sensor unit 30 is connected to the electronics safety path 20. To the extent that a failure or fault only affects the power supply, only the corresponding power-supply switches 12, 22 can be switched over. Similarly, only the signal switches 13, 23 can be switched over if the respectively active power-supply unit 11, 21 is not affected by the fault or failure.

The electronics main path 10 and the electronics safety path 20 here have identical functional ranges, in order to realize a complete redundancy of the electronics main path 10 and of the electronics safety path 20. But in alternative embodiments the electronics main path 10 and the electronics safety path 20 may also have only partly identical functional ranges, in order, for instance, to design merely functions that are relevant to safety in redundant manner.

According to the above statements, the rotation-angle detection system 1 consequently does not include any redundant sensor units with respective electronics paths for the purpose of signal-conditioning, but rather the redundancy is shifted to the signal-conditioning by the individual paths which have been designed to be at least partly redundant by virtue of the electronics main path 10 and the electronics safety path 20, which are each capable of being connected to the sensor unit 30 which has not been implemented in redundant manner.

FIG. 2 shows a schematic representation of a rotation-angle detection system 1′ for a rail vehicle, according to a second embodiment. The rotation-angle detection system 1′ of the second embodiment differs from the rotation-angle detection system 1 of the first embodiment in that in the second embodiment the sensor unit is constituted by a resolver 30′. In addition, in the rotation-angle detection system 1′ the power supply is effected in the form of an excitation signal for the resolver 30′, and the signal-conditioning is effected in accordance with sine-wave signals and cosine-wave signals received from the resolver 30′ in the electronics main path 10′ and electronics safety path 20′ respectively connected to the resolver 30′ via a resolver digital converter 18, 28 provided respectively in the electronics main path 10′ and in the electronics safety path 20′. The excitation signal is capable of being transmitted to the resolver 30′ either from the resolver digital converter 18 in the electronics main path 10′ or from the resolver digital converter 28 in the electronics safety path 20′, depending upon the switching of a respective excitation-signal switch 13a', 23a'. Corresponding to the excitation signal in conjunction with the current rotation angle of the rotary brake drive, the resolver 30′ outputs sine-wave signals and cosine-wave signals. Depending upon the switch position of a sine-wave-signal switch 13b', 23b′ arranged both in the electronics main path 10′ and in the electronics safety path 20′, the sine-wave signals are optionally transmitted to the resolver digital converter 18 in the electronics main path 10′ or to the resolver digital converter 28 in the electronics safety path 20′. In alternative embodiments, there may also be provision, for control reasons for instance, to communicate the sine-wave signals both to the resolver digital converter 18 in the electronics main path 10′ and to the resolver digital converter 28 in the electronics safety path 20′. In a manner comparable to the transmission of the sine-wave signals, the cosine-wave signals are optionally transmitted to the resolver digital converter 18 in the electronics main path 10′ or to the resolver digital converter 28 in the electronics safety path 20′, depending upon the switch position of a cosine-wave-signal switch 13c', 23c′ arranged both in the electronics main path 10′ and in the electronics safety path 20′. In alternative embodiments, there may also be provision, likewise for control reasons for instance, to communicate the cosine-wave signals both to the resolver digital converter 18 in the electronics main path 10′ or to the resolver digital converter 28 in the electronics safety path 20′.

The respective resolver digital converter 18, 28 has been designed in such a manner that the resolver digital converter 18, 28 determines a rotation angle of the rotary brake drive from the transmitted sine-wave signals and cosine-wave signals by forming the inverse tangent, and outputs this rotation angle for instance a higher-ranking control unit, such as the control unit 40.

### LIST OF REFERENCE SYMBOLS

1, 1′ rotation-angle detection system
10, 10′ electronics main path
11 power-supply unit (electronics main path)
12 power-supply switch (electronics main path)
13 signal switch (electronics main path)
13a excitation-signal switch (electronics main path)
13b′ sine-wave-signal switch (electronics main path)
13c′ cosine-wave-signal switch (electronics main path)
14 signal-converter (electronics main path)
15 signal-processing unit (electronics main path)
16 signal-output unit (electronics main path)
17 triggering signal (electronics main path)
18 resolver digital converter (electronics main path)
20,20′ electronics safety path
21 power-supply unit (electronics safety path)
22 power-supply switch (electronics safety path)
23 signal switch (electronics safety path)
23a excitation-signal switch (electronics safety path)
23b′ sine-wave-signal switch (electronics safety path)
23c cosine-wave-signal switch (electronics safety path)
24 signal-converter (electronics safety path)
25 signal-processing unit (electronics safety path)
26 signal-output unit (electronics safety path)
27 triggering signal (electronics safety path)
28 resolver digital converter (electronics safety path)
30 sensor
30′ resolver
40 control unit

1. A rotation-angle detection system for detecting a rotation angle of a rotary brake drive for a rail vehicle, the rotation-angle detection system exhibiting:
at least one sensor unit configured to detect a rotation angle operationally couplable to the rotary brake drive, and
at least one electronics main path and at least one electronics safety path per sensor unit, the at least one electronics main path and the at least one electronics safety path being operationally connectable to the at least one sensor unit, in each instance as an individual path,
wherein the at least one electronics main path and the at least one electronics safety path respectively exhibit at least one signal-conditioning unit.

2. The rotation-angle detection system of claim 1, wherein the sensor unit is endowed with a higher level of failure safety than the at least one electronics main path and/or the at least one electronics safety path.

3. The rotation-angle detection system of claim 1, wherein the signal-conditioning unit of the at least one electronics main path and/or of the at least one electronics safety path includes at least one signal-converter.

4. The rotation-angle detection system of claim 1, wherein the signal-conditioning unit of the at least one electronics main path and/or of the at least one electronics safety path includes at least one signal-processing unit.

5. The rotation-angle detection system of claim 1, wherein the signal-conditioning unit of the at least one electronics main path and/or of the at least one electronics safety path includes at least one signal-output unit.

6. The rotation-angle detection system of claim 1, wherein the at least one electronics main path and/or the at least one electronics safety path includes at least one signal switch via which the at least one signal-conditioning unit is operationally connectable to the at least one sensor unit.

7. The rotation-angle detection system of claim 1, wherein the at least one electronics main path and/or the at least one electronics safety path includes at least one power-supply unit operationally connectable to the at least one sensor unit.

8. The rotation-angle detection system of claim 1, wherein the at least one electronics main path and/or the at least one electronics safety path includes at least one power-supply switch via which the at least one power-supply unit operationally connectable to the at least one sensor unit,

9. The rotation-angle detection system of claim 6, wherein the at least one electronics main path and/or the at least one electronics safety path and/or the at least one signal switch and/or the at least one power-supply switch is/are triggerable via a triggering signal of a triggering unit.

10. The rotation-angle detection system of claim 1, wherein the sensor unit is a resolver or includes at least one resolver.

11. The rotation-angle detection system of claim 10, wherein the at least one electronics main path and/or the at least one electronics safety path includes at least one resolver digital converter.

12. The rotation-angle detection system of claim 11, wherein the at least one resolver digital converter is configured to excite a rotor of the resolver magnetically with an alternating voltage of constant amplitude, and to receive sine-wave signals and cosine-wave signals of a stator of the resolver.

13. The rotation-angle detection system of claim 12, wherein the at least one resolver digital converter or a further signal-conditioning unit are configured to determine the rotation-angle position from the sine-wave signals and cosine-wave signals of the stator of the resolver taking a number of pole-pairs of the resolver into consideration.

14. A braking system for a rail vehicle, the braking system comprising:
at least one brake actuator configured to apply a braking force,
at least one rotary brake drive configured to actuate the brake actuator, and
at least one rotation-angle detection system as claimed in claim 1.

15. A rail vehicle with comprising a braking system as claimed in claim 14, wherein at least the sensor unit is arranged in a truck of the rail vehicle.
